(19) United States
(12) Patent Application Publication
(10) Pub. No.: US 2024/0212416 A1
(43) Pub. Date: Jun. 27, 2024

(54) GEOGRAPHICAL DRAW-STYLE WAGERING WITH MOVABLE SELECTIONS

(71) Applicant: IGT, Las Vegas, NV (US)

(72) Inventors: Patrick DANIELSON, Las Vegas, NV (US); Dwayne NELSON, Las Vegas, NV (US)

(21) Appl. No.: 18/086,392

(22) Filed: Dec. 21, 2022

(51) Int. Cl. G07F 17/32

(52) U.S. Cl. CPC G07F 17/3206; G07F 17/329

(57) ABSTRACT

A gaming device includes a display device, an input device, a processor circuit, and a memory including instructions that, when executed by the processor circuit, cause the processor circuit to: receive, via the input device, an indication of a wager for a draw-style wagering game by a player using a gaming device, receive, via the input device, an indication of a selected movable object on a geographical image for the draw-style wagering game using the gaming device, cause the display device of the gaming device to display the geographical image including a geographical location, cause the display device to display characteristics of a drawn set of characteristics, determine whether the characteristic corresponds to the selected movable object, for each characteristic that corresponds to the selected movable object, determine that the characteristics are a hit, and display a hit indicator on the geographical image.

### BACKGROUND

Embodiments described herein relate to game play features with electronic wagering games, and in particular, to a draw-style wagering game for use in a gaming environment, such as in a casino environment, and related devices, systems, and methods. Examples of draw style wagering games include keno and lottery types of games. Players of different types of wagering games may be resistant to playing other types of wagering games for a number of reasons, including familiarity, loyalty, habit, and other reasons. For example, a player who primarily plays draw-style wagering games may be resistant to playing slot games, and vice versa. There is a need for different types of games to attract a wider variety of players of different wagering games.

### BRIEF SUMMARY

Some embodiments include a system that includes a processor circuit and a memory including machine-readable instructions that, when executed by the processor circuit, cause the processor circuit to receive an indication of a wager for a draw-style wagering game by a player using a gaming device. The processor circuit may be caused to receive an indication of a selected movable object on a geographical image for the draw-style wagering game using the gaming device. The processor circuit may be caused to cause a display device of the gaming device to display a graphical user interface (GUI) that includes the geographical image including multiple movable objects that include the selected movable object and the selected movable object on the geographical image. The display device may be caused to display a drawn set of characteristics corresponding to the movable objects. Some embodiments provide that for each characteristic of the drawn set of characteristics, operations include determining whether the drawn set of characteristics corresponds to any of the movable objects on the geographical image. For each characteristic of the drawn set of characteristics that corresponds to the selected movable object, the processor circuit may be caused to determine that the characteristic of the drawn set of characteristics is a hit and display a hit indicator at the selected movable object corresponding to the characteristic of the drawn set of characteristics. Based on a number of hits, the processor circuit may be caused to generate a game result for the draw-style wagering game. The processor circuit may be caused to, in response to the game result being a winning game result, provide an award the player of the draw-style wagering game.

Embodiments herein may include a gaming device that includes a display device, an input device, a processor circuit, and a memory including machine-readable instructions that, when executed by the processor circuit, cause the processor circuit to receive, via the input device, an indication of a wager for a draw-style wagering game by a player using a gaming device. The processor circuit further receives, via the input device, an indication of a selected movable object on a geographical image for the draw-style wagering game using the gaming device and to cause the display device of the gaming device to display the geographical image comprising a geographical location. The processor circuit may further cause the display device to display characteristics of a drawn set of characteristics and, for each characteristic of the drawn set of characteristics, determine whether the characteristic of drawn characteristics correspond to the selected movable object. The processor circuit may further be caused to, for each characteristic of the drawn characteristics that corresponds to the selected movable object, determine that the characteristic of the drawn characteristics is a hit, and display a hit indicator on the geographical image and generate a game result for the draw-style wagering game. The processor circuit is further caused to, in response to the game result being a winning game result, provide an award to the player of the draw-style wagering game.

Operations of systems/methods for performing embodiments include receiving a wager for a geographic map based gridless keno-style selected movable object wagering game at a gaming device and receiving multiple selected movable objects for the geographic map based gridless keno-style wagering game at the gaming device. Operations include causing a display device of the gaming device to display a geographical map including a geographical location and the selected movable objects and causing the display device to display characteristics of a drawn set of characteristics. Operations further include, for each characteristic of the drawn set of characteristics, determining whether the characteristic of drawn characteristics correspond to ones of the selected movable objects and, for each characteristic of the drawn characteristics that corresponds to one of the selected movable objects, determining that the characteristic of the drawn characteristics comprises a hit. Operations include generating, based on a quantity of hits, a game result for the geographic map based gridless keno-style selected movable object wagering game and, in response to the game result being a winning game result, providing an award to a player.

### BRIEF DESCRIPTION OF SEVERAL VIEWS OF THE DRAWINGS

FIG. 1 is a partial schematic geographical map of an area for movable object draw type wagering in accordance with some embodiments herein.

FIG. 2 is a schematic illustration of a sample paytable that may be similar to a keno-style paytable for movable object draw type wagering according to some embodiments.

FIG. 3 is a schematic block diagram that illustrates the selected and drawn geographical areas with a map as the playfield for movable object draw type wagering according to some embodiments.

FIG. 4 is a schematic block diagram illustrating a network configuration for a plurality of gaming devices according to some embodiments.

FIG. 5A is a schematic block diagram illustrating an electronic configuration for a gaming device according to some embodiments.

FIG. 5B is a schematic block diagram that illustrates various functional modules of a gaming device according to some embodiments.

FIG. 5C is perspective view of a gaming device that can be configured according to some embodiments.

FIG. 6 is a flowchart illustrating operations of systems/methods of facilitating participation in a movable object draw type wagering game, according to some embodiments.

FIG. 7 is a flowchart illustrating operations of systems/methods of facilitating participation in a movable object draw type wagering game, according to some embodiments.

FIG. 8 is a flowchart illustrating operations of systems/methods of facilitating participation in a movable object draw type wagering game, according to some embodiments.

### DETAILED DESCRIPTION

Embodiments described herein relate to game play features with electronic wagering games, and in particular, to draw style wagering games such as keno and/or lottery wagering games. Some embodiments provide a draw style wagering game in which a player may choose geographical locations on a map or globe instead of choosing numbers from a range and/or from a keno card. In some embodiments, the user is presented with a map and/or globe via a display device that displays a graphical user interface (GUI). In some embodiments, the user may pay to place a pin marker on the map/globe. The draw style wagering game may, using a random drawing process, pick a location on the map/globe and the person with the pin that is the closest to the drawn geographical location wins. In some embodiments, a winner may be chosen by some distance, area and/or radius around the chosen pin, such as 10 meters. Some embodiments herein may provide the inclusion of advertising and/or charitable giving components.

Previously some systems have converted maps into grids of multiple rectangular shapes thus making the map a simple analogy for lottery numbers. In contrast, embodiments herein allow the player to pick any place without restrictions. Further, the player may alter the shape and/or size of the selected area. In some embodiments, the selected geographical area may be further defined to include three-dimensional (3D) areas. In some embodiments, players may select multiple locations, which may be similar to a 5 number lottery system and/or a keno card with 20 numbers picked randomly by the system. Such advantages may be significant. Some embodiments provide that the geographical area may be irregular shapes and not merely square keno cards with square keno numbers aligned in a perfect grid. In such embodiments, the geographical area may be gridless.

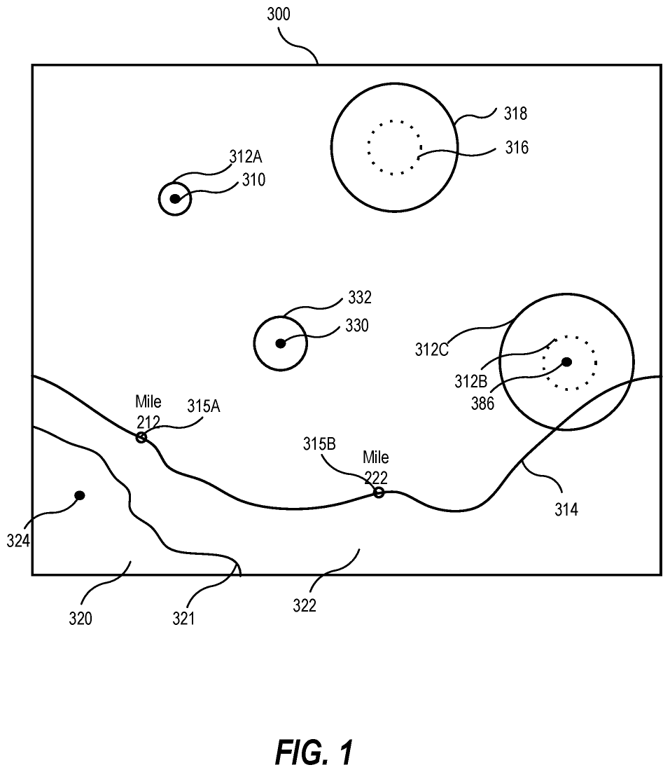

The present disclosure involves a keno or lottery system that allows the user to choose locations and interactions between stationary and movable objects on a map or globe instead of choosing numbers. In the simplest embodiment the user is presented a map or globe instead of a regular keno card or range or numbers. The user pays to place a pin marker on the globe. The draw picks a location on the map or globe and the person with the closest pin wins. In one embodiment the winner is chosen by some distance, area or radius around the chosen pin, such as 10 meters. Reference is made to FIG. 1, which is a partial schematic geographical map of an area for selecting movable objects in accordance with some embodiments herein. As illustrated, the player may place a pin 310 that identifies a selected geographical position of the geographical map.

In some embodiments, the player may further define an area on the geographical map by including a radius 312A around the pin 310.

In some embodiments, the player of the game might choose a special place such as their birthplace, hometown, desired vacation destination, desired retirement location, a property they wish to purchase, the location of a loved one, the location where they met someone special and/or the location of a favorite sports team, among others.

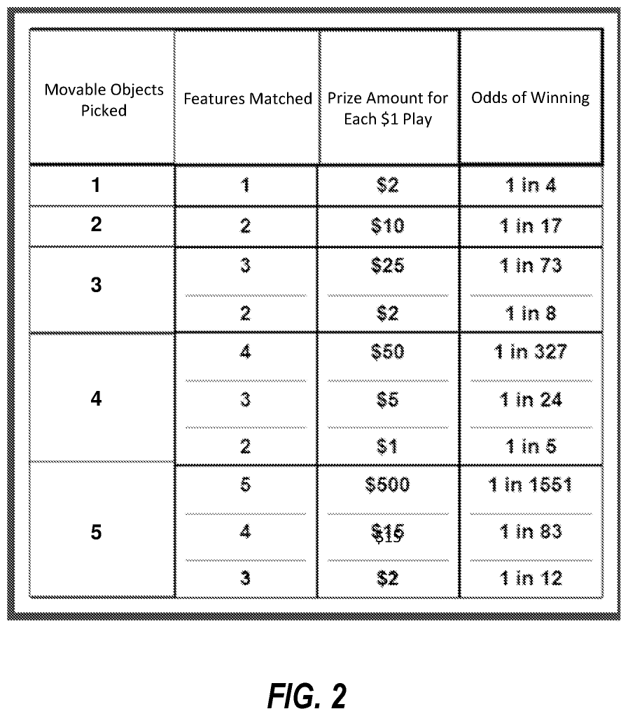

While only showing a single pin 310, embodiments herein provide that a player my pick multiple pin locations. In some embodiments, the example image shows a map and one pin, but multiple draws may be pinned onto the geographical map. In some embodiments, the value of the pins 310 may be determined by a paytable. For example, brief reference is now made to FIG. 2, which is a schematic illustration of a sample paytable that may be similar to a keno-style paytable according to some embodiments. Some embodiments may leverage other Keno concepts, such as the player picking spots and/or allowing the system to randomly choose them for the player (sometimes called the “Quick Pick” feature). Some embodiments can be played at a video Keno terminal, mobile application and/or website. Some embodiments may be implemented as a traditional keno game with an overhead sign displaying the random locations and the players viewing their “Keno Cards” on player mobile devices. In this manner, the present disclosure is distinct from a traditional Keno system.

Some embodiments are directed to a draw type game, such as keno or lottery, that allows the user to choose a virtual or real-world moving object instead of choosing numbers from a range or from a keno card. In some embodiments, the player may be presented a map and/or a globe with people and/or objects that regularly move. The player pays to place a pin marker on a predetermined moving item for a later occurring draw date. The keno or lottery draw process may pick a location on the map, globe, and/or other grid randomly. In some embodiments, the person with the object nearest the pin may win if the time and place selected as follows. A win may be determined based on the time and place directly hitting the selected target in a geographic position at a specific time and/or time interval. A player may also win if the time and place are near the travel path of a geo-tracked item at a specific time and place A player may further win if the time and place are closest to the select item during the real-time draw.

Some embodiments provide that the moving object is irrelevant to the draw and the randomness is determined by the alignment of the static position while the draw occurs. In this manner, the results may be impossible to predict. This may allow a wide variety of math models to be in place for awards and prizes through the variability of the moving object.

The winner may be chosen by some distance, area, and/or radius around the chosen moving object, such as 1 to 100 kilometers away the moving object during the draw. Some embodiments provide that applications for advertising and charitable giving using this method may be advantageous.

A combination may be that physical and stationary positioning could be employed via a combination of draws to increase the probability of prize pools. For example, different combinations include starting and end position, distance traveled, speed, and altitude.

Other dynamics may include time slots, in either day, hour, or minute or the alignment of more than one moving people and/or places. If a lottery position is pulled that crosses the path or is within the timeframe of the moving object during the draw then a win may be determined.

These concepts may be combined with other forms of gaming, such as sports betting, among others. A player position could be predicted with the randomness of the draw on the field. Such embodiments may be scaled for special events. Some embodiments include an unknown variable that is in place by selecting a big game location, sports teams matching, and/or other variation that could decrease the probability of the random draw.

In some embodiments, a player selects an aircraft 310 where the geo-position is trackable during the voyage. A random geographic position is selected. If the moving object is within a set parameter if the position (e.g., 10 kilometers), then the player is a winner.

In some embodiments, a player selects a sports team and super bowl location next year for a timed draw as an odds modifier to adjust probabilities. If the team is at the big game at the selected stadium and that geo-location is pulled, that will allow a higher odds rating via the probability model.

Some embodiments include a player selecting a vehicle. The present invention will now be described in terms of the players choosing a vehicle 316 having a specific radius 318 that defines an area around the vehicle, such as a passenger car on a man.

In some embodiments, the draw picks one or more pin locations on the play map. Each pin has a shape and a size. For example, if the shape is a circle the pin location might be the center of the circle and the winning location is 1 km around the center of the circle. In one embodiment, any cars in the circle are winners or eligible for evaluation. If no winners are in the circle, there can be no winner and the size (radius) of the winning shape (circle) can be increased until a winner is found.

In some embodiments, the players wager on the number of vehicles in a selected location. For example, a player may wager that 3 cars will be in the radius. This type of wager may be in combination with the location. For example, the player might pick a certain vehicle and then also wager that 3 cars will be in the selected location with the winning vehicle.

Players may wager on a specific vehicle using the VIN or MAC address of the vehicle. Players may wager on the make, model, year, color, velocity, state (parked, moving) of vehicle or any combination of those parameters. Additionally, factors that may be defined include license plate information, such as state of registration or presence of a given symbol, road types such as off-road, interstate, and/or vehicle identification number (VIN), among others. For example, the player could wager that Elon Musk's car will be parked. If the draw picks a pick and Elon Musk's cars is withing the radius corresponding to the pick and is parked, the player wins.

In some embodiments, the system chooses a road 314 and one or more mile markers 315A, 315B or other feature that defines the distance on the road 314. In this manner, a player may be unable to pick pins in locations where no one can travel. For example, the system picks the highway I-80 and mile marker 21. The system may pick a travel direction the vehicle must be traveling (north, south, east, west, etc.). The system may also pick locations that are not roads, but would have cars such as parking lots, parking garages, docs, etc.

In some embodiments, other factors that may be layered to generate a wagering opportunity based on moving objects include velocity, direction of travel, number of occupants, fuel type, vehicle weight, number of axles, number of wheels, (e.g., motorcycle), whether human controlled or self-driving, and/or self-reporting, among others.

In some embodiments, factors may further include type of vehicle including an airborne vehicle, water vehicle, terrestrial vehicle and/or extra-terrestrial vehicle, such as a satellite. Any of these factors listed above may be used in combination with one another and with the movement and/or location information of and/or by movable objects.

In some embodiments, a pin 310 may include an initial radius 312B that may increase to a greater radius 312C over time if not of the selected events occurs within a given time interval.

In some embodiments, the geographical area may include different terrain type include types of terrestrial and types of water environments. For example, in the context herein, the vehicle 324 may include a boat and the terrain may be water 320 that is defined by shoreline 321 on the land 322.

In the current embodiments, the player may make 5 picks, shown as solid line circles 382.

In some embodiments, the selected geographical areas may be the same size, whereas some other embodiments provide that the selected geographical areas may be different sizes. For example, the selected geographical area of circles 312, 318 may be different sizes from one another. In other embodiments the selected geographical areas may be of different shapes.

In some embodiments, the present disclosure may not utilize a map. In some embodiments, the playfield may be a shape of a certain color and/or image. However, the geographical area may include a map.

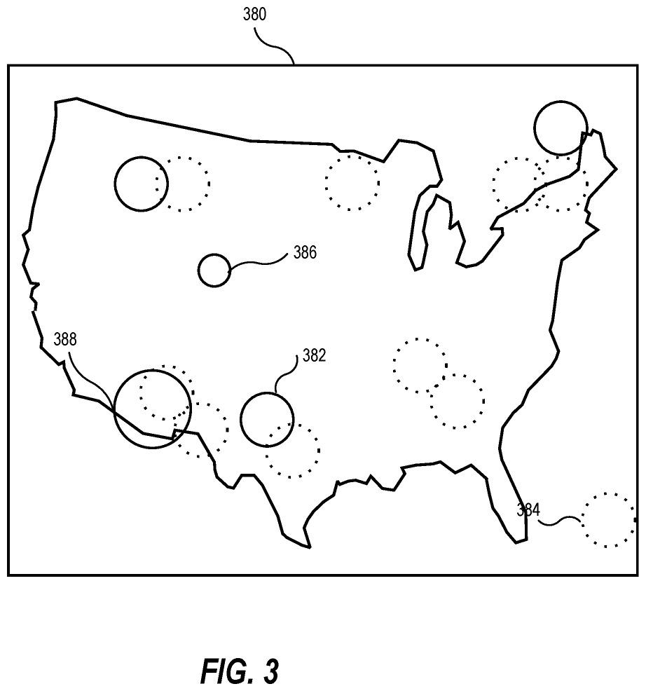

For example, brief reference is now made to FIG. 3, which is a schematic block diagram that illustrates the selected and drawn geographical areas of a map as the playfield according to some embodiments.

In some embodiments, the user can place the pin and specify a radius. The larger the radius, the more likely the player is to win. In some embodiments, the cost increases for the wager proportionally to the area covered. In some embodiments, the player can place a shape such as a square, diamond and/or heart and may scale the shape and/or may change the orientation of the shape. In some embodiments, the winning shape must intersect with the shape chosen during the lottery draw. In some embodiments, the player is allowed to upload and use a custom shape or icon. For example, the player could upload a logo from their favorite sports team and place it on the map. That icon could be the NFL Raiders logo and the player might place it on the Stadium for the location of the next SuperBowl.

In some embodiments, the pin location may have multiple meanings. For example, a first meaning is that the player is choosing a location (or multiple locations) they hope will be randomly chosen by the system. In addition to this evaluation or alternatively to this evaluation, the pin location could present another wager. For example, the player may place the pin on Raider Stadium in Las Vegas and 4 other locations. The game may be played in which the system chooses 20 random locations on the map. The player may be awarded, based on a payment schedule, for any player pins near the 20 random locations. The player may also win if the Raiders win the Super Bowl, win the next game and/or win some wager specifically related to the Raider Stadium.

In some embodiments, a player user interface may allow the player to search for certain markers such as a particular logo. This may allow people in social groups to see what other members of their group are doing and/or to possibly make a statement.

In one embodiment the player can create an area such as a free form shape such as an oval. The user interface would evaluate the amount of area created and display the amount of money the player would need to bet based on using that free form shaped area. Since the player can select areas or create pins of varying radius, some embodiments provide that the user interface may show the player the amount of area selected and/or the odds or approximate odds of winning. For example, in response to the player drawing an area with their finger, system may show that the player selected 23 square meters, which has the odds of 1 in 230 million and costs $7.

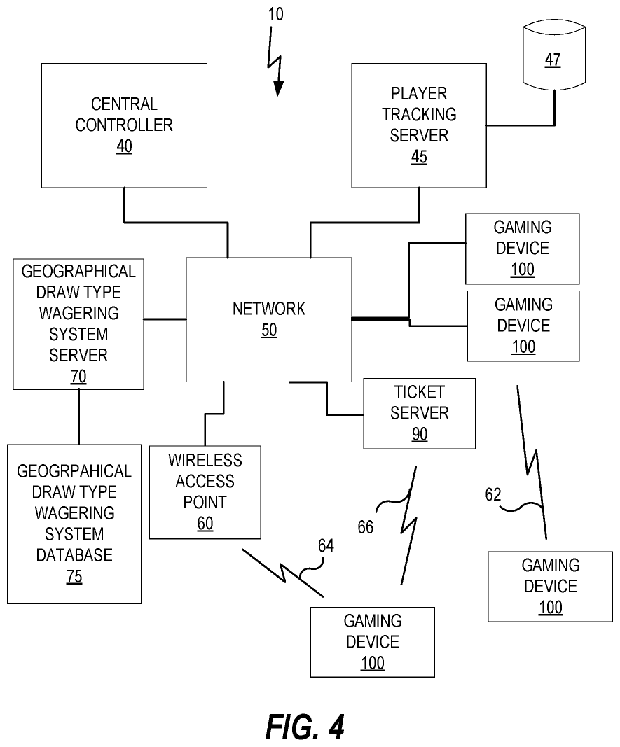

Referring now to FIG. 4, a gaming system 10 including a plurality of gaming devices 100 is illustrated. As discussed above, the gaming devices 100 may be one type of a variety of different types of gaming devices, such as electronic gaming machines (EGMs), mobile gaming devices, virtual lottery kiosks, keno terminals/and or kiosks and/or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 4, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

A geographical draw type wagering system server 70 may manage access, update, storage, evaluation, outcome determination, and/or multiplayer game status. The geographical draw type wagering system may be stored in a geographical draw type wagering system database 75. The geographical draw type wagering system server 70 and/or geographical draw type wagering system database 75 may be implemented within or separately from each other.

As further illustrated in FIG. 4, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

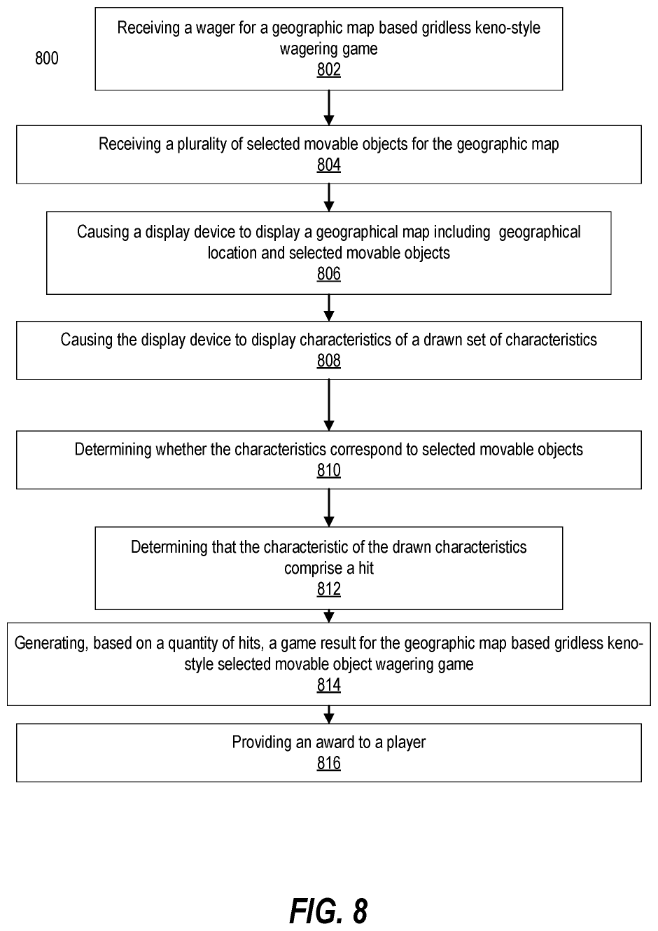

Embodiments herein may include different types of gaming devices. One example of a gaming device includes a gaming device 100 that can use gesture and/or touch-based inputs according to various embodiments is illustrated in FIGS. 8A-8C.

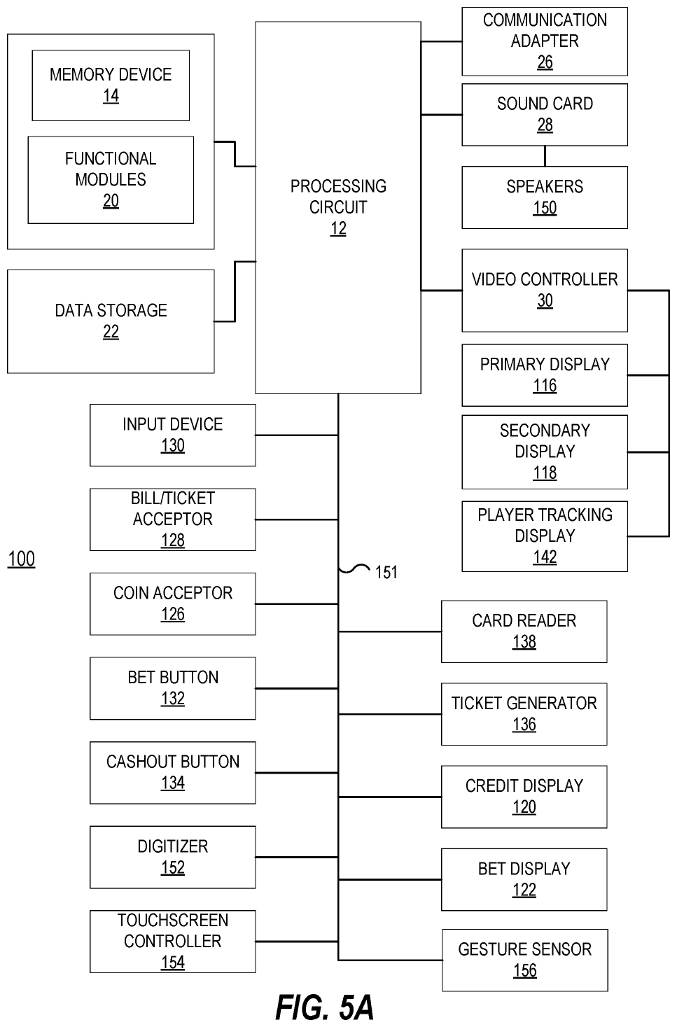

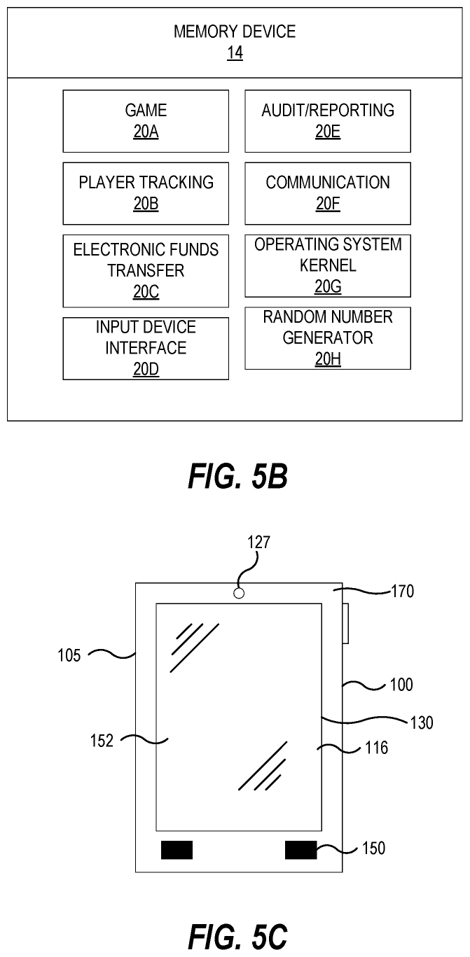

Reference is now made to FIG. 5A, which is a functional block diagram that schematically illustrates an electronic relationship of various elements of the gaming device, FIG. 5B, which illustrates various functional modules that can be stored in a memory device of the gaming device, and FIG. 5C, which is a perspective view of a gaming device that can be configured according to some embodiments.

The embodiments shown in FIGS. 8A-8C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of features, many of which are illustrated in FIGS. 8A and 8B. For example, referring to FIG. 5A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 5A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 5A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cash-out button 134. The cash-out button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIG. 5A includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 5A, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 142. Accordingly, any of the above-described input devices, such as the input device 130, the game play initiation button 132 and/or the cash-out button 134 may be provided as virtual buttons or regions on one or more of the display devices 116, 118, 142.

Still referring to FIG. 5A, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

The display devices 116, 118, 142 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 142 may include a touch-screen with an associated touchscreen controller 154 and digitizer 152. The display devices 116, 118, 142 may be of any suitable size, shape, and/or configuration. The display devices 116, 118, 142 may include flat or curved display surfaces.

The display devices 116, 118, 142 and video controller 30 of the gaming device 100 are generally configured to display one or more game and/or non-game images, symbols, and indicia. In certain embodiments, the display devices 116, 118, 142 of the gaming device 100 are configured to display any suitable visual representation or exhibition of the movement of objects; dynamic lighting; video images; images of people, characters, places, things, and faces of cards; and the like. In certain embodiments, the display devices 116, 118, 142 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 142 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

The gaming device 100 may also include a currency dispenser that may include a note dispenser configured to dispense paper currency and/or a coin generator configured to dispense coins or tokens in a coin payout tray.

The gaming device 100 may further include one or more speakers 150 controlled by one or more sound cards 28. The gaming device 100 illustrated in FIG. 5A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 142 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 5A is a block diagram that illustrates logical and functional relationships between various components of a gaming device 100. It should also be understood that components described in FIG. 5A may also be used in other computing devices, as desired, such as mobile computing devices for example. As shown in FIG. 5A, the gaming device 100 may include a processing circuit 12 that controls operations of the gaming device 100. Although illustrated as a single processing circuit, multiple special purpose and/or general purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 5A as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 5C.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 142 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 5B. Referring to FIG. 5B, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 5C, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cash-out button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, geographical draw type games, or other casino or non-casino style games. Further, gaming devices according to embodiments herein may be implemented using other computing devices and mobile devices, such as smart phones, tablets, and/or personal computers, among others.

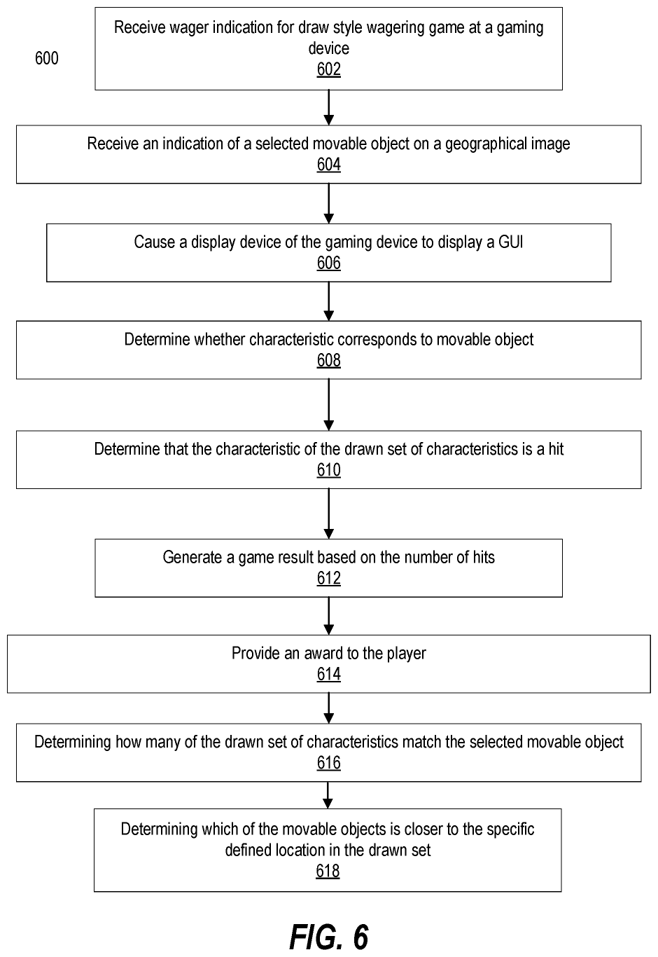

Reference is now made to FIG. 6, which is a flowchart illustrating operations 900 of systems/methods for performing embodiments described herein. Embodiments include a system that includes a processor circuit and a memory including machine-readable instructions that, when executed by the processor circuit, cause the processor circuit to receive (Block 602) an indication of a wager for a draw-style wagering game by a player using a gaming device. The processor circuit may be caused to receive (Block 604) an indication of a selected movable object on a geographical image for the draw-style wagering game using the gaming device. The processor circuit may be caused to cause (Block 606) a display device of the gaming device to display a graphical user interface (GUI) that includes the geographical image including multiple movable objects that include the selected movable object and the selected movable object on the geographical image. The display device may be caused to display a drawn set of characteristics corresponding to the movable objects. Some embodiments provide that for each characteristic of the drawn set of characteristics, operations include determining (Block 608) whether the drawn set of characteristics corresponds to any of the movable objects on the geographical image. For each characteristic of the drawn set of characteristics that corresponds to the selected movable object, the processor circuit may be caused to determine (Block 610) that the characteristic of the drawn set of characteristics is a hit and display a hit indicator at the selected movable object corresponding to the characteristic of the drawn set of characteristics. Based on a number of hits, the processor circuit may be caused to generate (Block 612) a game result for the draw-style wagering game. The processor circuit may be caused to, in response to the game result being a winning game result, provide (Block 614) an award the player of the draw-style wagering game.

In some embodiments, the geographical image includes a map image corresponding to a real and/or fictious geographical location that is configured to display the selected movable object as a location on the map image.

Some embodiments provide that the selected movable object includes one of multiple of user selectable shapes and/or shape sizes, and wherein a wager amount is determined based on a selected shape and/or shape size. Some embodiments provide that the selected movable object comprise a time value that defines a time interval during which characteristics of the selected movable object are evaluated. In some embodiments, the selected movable object includes a motion related characteristic that corresponds to motion of the selected movable object relative during the time interval. For example, the player may pick one or more characteristics and/or locations that are wagered to occur during a defined time interval. In some embodiment, if the selected characteristics and/or locations do not occur during the time interval, the wager may be terminated, reduced to a lower potential award amount and/or extended to a new time period having a different potential payout.

Some embodiments provide that the selected movable object includes a specific vehicle and that determining that the characteristic of the drawn set of characteristics is a hit includes determining how many of the drawn set of characteristics match the selected movable object.

In some embodiments, one characteristic of the drawn set of characteristics includes visible vehicle character characteristics. Examples of visible vehicle characteristics include color, make/model, number of occupants, vehicle type (e.g., car, truck, service vehicle, boat, aircraft, motorcycle), and/or externally mounted equipment such as lights, cargo racks, and/or door types, among others.

In some embodiments, a characteristic of the drawn set of characteristics includes vehicle origination features such as state of registration and/or vehicle manufacturer, among others.

Some embodiments provide that the drawn set of characteristics includes a specific defined location and that determining the hit includes determining which of the movable objects is closer to the specific defined location in the drawn set. The award may be determined based on a distance between the specific defined location and the selected movable object during a predefined time interval.

In some embodiments, the selected movable object includes a radius that is configured to increase in size responsive to not being a hit based on a location in the drawn set of characteristics. Some embodiments provide that, in response to an increase in size of the radius, the award reduces in value. In some embodiments, the drawn set of characteristics includes a quantity of vehicles that are in the radius at a given time. Some embodiments provide that the drawn set of characteristics includes a first vehicle type and a second vehicle type that is different form the first vehicle type. The first vehicle type and the second vehicle type include one of an airborne vehicle, a terrestrial vehicle and an aquatic vehicle, among others. In some embodiments, the drawn set of characteristics includes a first vehicle type and a second vehicle type that is different form the first vehicle type and provide that the first vehicle type and the second vehicle type include one of an autonomous vehicle and human operated vehicle.

In some embodiments, the drawn set of characteristics includes a specific road portion. Some embodiments provide that the specific road portion is configured to increase in length responsive to not being the hit based on a location in the drawn set of characteristics. In some embodiments, in response to an increase in length of the specific road portion, the award reduces in value.

In some embodiments, the geographical image comprises a three-dimensional space in which the selected movable object is selected to comprise altitude and the drawn set of characteristics comprises altitude.

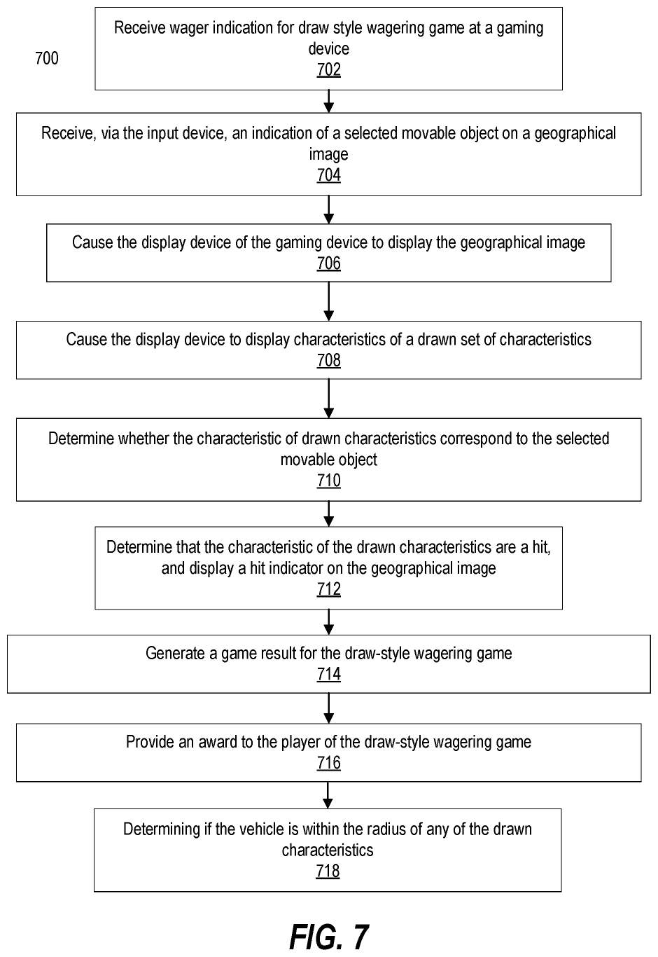

Reference is now made to FIG. 7, which is a flowchart illustrating operations 700 of systems/methods for performing embodiments described herein. Some embodiments include a gaming device that includes a display device, an input device, a processor circuit, and a memory including machine-readable instructions that, when executed by the processor circuit, cause the processor circuit to receive (Block 702), via the input device, an indication of a wager for a draw-style wagering game by a player using a gaming device. The processor circuit further receives (Block 704), via the input device, an indication of a selected movable object on a geographical image for the draw-style wagering game using the gaming device and to cause (Block 706) the display device of the gaming device to display the geographical image comprising a geographical location. The processor circuit may further cause (Block 708) the display device to display characteristics of a drawn set of characteristics and, for each characteristic of the drawn set of characteristics, determine (Block 710) whether the characteristic of drawn characteristics correspond to the selected movable object. The processor circuit may further be caused to, for each characteristic of the drawn characteristics that corresponds to the selected movable object, determine (Block 712) that the characteristic of the drawn characteristics is a hit, and display a hit indicator on the geographical image and generate (Block 714) a game result for the draw-style wagering game. The processor circuit is further caused to, in response to the game result being a winning game result, provide (Block 716) an award to the player of the draw-style wagering game.

In some embodiments, the selected movable object includes a vehicle that is identified using a vehicle identification number (VIN) and the drawn characteristics include a location on the geographical image that includes a point and a radius. Some embodiments provide that, determining whether any of the drawn characteristics corresponds to the selected movable object includes determining if the vehicle is within the radius of any of the drawn characteristics.

Reference is now made to FIG. 8, which is a flowchart illustrating operations 800 of systems/methods for performing embodiments described herein. Operations include receiving (Block 802) a wager for a geographic map based gridless keno-style selected movable object wagering game at a gaming device and receiving (Block 804) multiple selected movable objects for the geographic map based gridless keno-style wagering game at the gaming device. Operations include causing (Block 806) a display device of the gaming device to display a geographical map including a geographical location and the selected movable objects and causing (Block 808) the display device to display characteristics of a drawn set of characteristics. Operations further include, for each characteristic of the drawn set of characteristics, determining (Block 810) whether the characteristic of drawn characteristics correspond to ones of the selected movable objects and, for each characteristic of the drawn characteristics that corresponds to one of the selected movable objects, determining (Block 812) that the characteristic of the drawn characteristics comprises a hit. Operations include generating (Block 814), based on a quantity of hits, a game result for the geographic map based gridless keno-style selected movable object wagering game and, in response to the game result being a winning game result, providing (Block 816) an award to a player.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory comprising machine-readable instructions that, when executed by the processor circuit, cause the processor circuit to:
receive an indication of a wager for a draw-style wagering game by a player using a gaming device;
receive an indication of a selected movable object on a geographical image for the draw-style wagering game using the gaming device;
cause a display device of the gaming device to display a graphical user interface (GUI) comprising:
the geographical image comprising a plurality of movable objects that comprises the selected movable object; and
the selected movable object on the geographical image;
cause the display device to display a drawn set of characteristics corresponding to the plurality of movable objects;
for each characteristic of the drawn set of characteristics, determine whether the drawn set of characteristics corresponds to any of the plurality of movable objects on the geographical image;
for each characteristic of the drawn set of characteristics that corresponds to the selected movable object, determine that the characteristic of the drawn set of characteristics is a hit and display a hit indicator at the selected movable object corresponding to the characteristic of the drawn set of characteristics;
based on a number of hits, generate a game result for the draw-style wagering game; and
in response to the game result being a winning game result, provide an award the player of the draw-style wagering game.

2. The system of claim 1, wherein the geographical image comprises a map image corresponding to a real and/or fictious geographical location that is configured to display the selected movable object as a location on the map image.

3. The system of claim 2, wherein the selected movable object comprises one of a plurality of user selectable shapes and/or shape sizes, and wherein a wager amount is determined based on a selected shape and/or shape size.

4. The system of claim 2, wherein selected movable object comprise a time value that defines a time interval during which characteristics of the selected movable object are evaluated.

5. The system of claim 4, wherein the selected movable object comprises a motion related characteristic that corresponds to motion of the selected movable object relative during the time interval.

6. The system of claim 1, wherein the selected movable object comprises a specific vehicle, and wherein determining that the characteristic of the drawn set of characteristics is a hit comprises determining how many of the drawn set of characteristics match the selected movable object.

7. The system of claim 1, wherein one characteristic of the drawn set of characteristics comprises visible vehicle characteristics.

8. The system of claim 1, wherein one characteristic of the drawn set of characteristics comprises vehicle origination features.

9. The system of claim 1, wherein the drawn set of characteristics comprises a specific defined location,
wherein determining the hit comprise determining which of the plurality of movable objects is closer to the specific defined location in the drawn set, and
wherein, the award is determined based on a distance between the specific defined location and the selected movable object during a predefined time interval.

10. The system of claim 1, wherein the selected movable object comprises a radius that is configured to increase in size responsive to not being a hit based on a location in the drawn set of characteristics.

11. The system of claim 10, wherein responsive to an increase in size of the radius, the award reduces in value.

12. The system of claim 10, wherein the drawn set of characteristics comprises a quantity of vehicles that are in the radius at a given time.

13. The system of claim 10, wherein the drawn set of characteristics comprises a first vehicle type and a second vehicle type that is different form the first vehicle type, wherein the first vehicle type and the second vehicle type comprise one of an airborne vehicle, a terrestrial vehicle and an aquatic vehicle.

14. The system of claim 10, wherein the drawn set of characteristics comprises a first vehicle type and a second vehicle type that is different form the first vehicle type, wherein the first vehicle type and the second vehicle type comprise one of an autonomous vehicle and human operated vehicle.

15. The system of claim 1, wherein the drawn set of characteristics comprises a specific road portion.

16. The system of claim 15, wherein the specific road portion is configured to increase in length responsive to not being the hit based on a location in the drawn set of characteristics, and wherein, responsive to an increase in length of the specific road portion, the award reduces in value.

17. The system of claim 1, wherein the geographical image comprises a three-dimensional space in which the selected movable object is selected to comprise altitude and the drawn set of characteristics comprises altitude.

18. A gaming device comprising:
a display device;
an input device;
a processor circuit; and
a memory comprising machine-readable instructions that, when executed by the processor circuit, cause the processor circuit to:
receive, via the input device, an indication of a wager for a draw-style wagering game by a player using a gaming device;
receive, via the input device, an indication of a selected movable object on a geographical image for the draw-style wagering game using the gaming device;
cause the display device of the gaming device to display the geographical image comprising a geographical location;
cause the display device to display characteristics of a drawn set of characteristics;
for each characteristic of the drawn set of characteristics, determine whether the characteristic of drawn characteristics correspond to the selected movable object;
for each characteristic of the drawn characteristics that corresponds to the selected movable object, determine that the characteristic of the drawn characteristics is a hit, and display a hit indicator on the geographical image;
generate a game result for the draw-style wagering game; and
in response to the game result being a winning game result, provide an award to the player of the draw-style wagering game.

19. The gaming device of claim 18, wherein the selected movable object comprises a vehicle that is identified using a vehicle identification number (VIN),
wherein the drawn characteristics comprise a location on the geographical image that comprises a point and a radius, and
wherein determining whether any of the drawn characteristics corresponds to the selected movable object comprises determining if the vehicle is within the radius of any of the drawn characteristics.

20. A method comprising:
receiving a wager for a geographic map based gridless keno-style selected movable object wagering game at a gaming device;
receiving a plurality of selected movable objects for the geographic map based gridless keno-style wagering game at the gaming device;
causing a display device of the gaming device to display a geographical map comprising a geographical location and the selected movable objects;
causing the display device to display characteristics of a drawn set of characteristics;
for each characteristic of the drawn set of characteristics, determining whether the characteristic of drawn characteristics correspond to ones of the plurality of selected movable objects;
for each characteristic of the drawn characteristics that corresponds to one of the plurality of selected movable objects, determining that the characteristic of the drawn characteristics comprises a hit;
generating, based on a quantity of hits, a game result for the geographic map based gridless keno-style selected movable object wagering game; and
in response to the game result being a winning game result, providing an award to a player.
